(19) United States
(12) Patent Application Publication
(10) Pub. No.: US 2008/0182761 A1
(43) Pub. Date: Jul. 31, 2008

(54) Fracture Acidizing Method Utilitzing Reactive Fluids and Deformable Particulates

(75) Inventors: Christopher John Stephenson, Houston, TX (US); Jeffrey C. Dawson, Spring, TX (US); Leonard J. Kalfayan, Cypress, TX (US); Qi Qu, Spring, TX (US); Sergey Stolyarov, Houston, TX (US)

Correspondence Address: JONES & SMITH , LLP, 2777 ALLEN PARKWAY, SUITE 800, HOUSTON, TX, 77019, US

(73) Assignee: BJ Services Company

(21) Appl. No.: 12/019,723

(22) Filed: Jan. 25, 2008

Related U.S. Application Data
(60) Provisional application No. 60/897,626, filed on Jan. 26, 2007.

(51) Int. Cl. C09K 8/90

(52) U.S. Cl. 507/104

(57) ABSTRACT

The productivity of sandstone or carbonate formations is enhanced by contacting the formation with a deformable particulate and a HF-containing acidizing solution. The deformable particulates create a partial monolayer in the formation while the HF-containing acidizing solution differentially etches the rock around the deformable particulate. The surface of the formation is partially blocked from reaction with the acidizing solution by the creation of the partial monolayer. Conductive channels are therefore created on the surface of the formation. The deformable particulates deform on closure. As the closure stress increases, the formation faces compress the non-dissolved, sandwiched formation points. These points function as pillars of un-reacted formation and act similar to a partial monolayer of proppant, providing the highly conductive channels.

This application claims the benefit of U.S. patent application Ser. No. 60/897,626, filed on Jan. 26, 2007, which is herein incorporated by reference.

### FIELD OF THE INVENTION

The invention relates to a method of enhancing the productivity of hydrocarbons from sandstone or carbonate formations by use of deformable particulates and an acidizing solution. The invention further relates to a well treating fluid containing the deformable particulates and acidizing solution.

### BACKGROUND OF THE INVENTION

Acid fracturing is a well known technique which may be employed as an alternative to conventional hydraulic fracturing for stimulation of acid soluble formations. To date, it has been mostly confined to carbonate formations, such as chalk, limestone and dolomites, and typically is employed to either bypass formation damage or to stimulate undamaged formations in order to enhance the flow of hydrocarbons to the wellbore.

The most common method of acid fracturing consists of introducing into the wellbore corrosive, very low pH acids and allowing the acid to react with the surrounding formation. Acids such as hydrochloric acid, formic acid, and acetic acid are injected at high rates and pressures into the formation to intentionally cause the formation to fail by inducing a fracture in the subterranean rock. This fracture, originating adjacent to the wellbore, initiates as two wings growing away from the wellbore in opposite directions. The acid is used to dissolve or etch channels or grooves along the fracture face so that after pressure is relieved and the fracture heals, there continues to exist non-uniform highly conductive channels, allowing unrestrained hydrocarbon flow from the reservoir to the wellbore. In contrast, with propped fracturing, fracture conductivity is maintained by propping open the created fracture with a solid material, such as sand, bauxite, ceramic, and certain lighter weight materials. Thus, the major difference between acid fracturing and hydraulic fracturing is that conductivity in acid fracturing is obtained by etching of the fracture faces with an etching acid instead of by using proppants to prevent the fracture from closing.

Ever since the introduction of propped fracturing to carbonate formations (after its original limitation to sandstones), fracture acidizing has been viewed largely as the less preferred alternative to propped fracturing. This is understandable, given that the treatment objectives and processes have been fundamentally similar—the creation of a long conductive fracture channel extending from the wellbore into the formation. In both cases, fracture height is principally controlled by the stress contrasts in bounding rock layers; and fracture length depends upon the height containment and the leak-off properties of the fracturing fluid. The preference for propped fracturing may further be attributable to the fact that propped fracturing is more easily modeled (non-reactive fluids; stable leak-off) and does not utilize fluids (acids) that are still widely feared, or at least avoided.

While fracture acidizing continues today as the less-preferred alternative to propped hydraulic fracturing in carbonates, it has never been seriously considered for sandstones since sandstone surfaces have been known not to be etched by acid in the same manner as fractures in carbonate formations are etched with HCl acid and/or organic acids.

With approximately 70% of worldwide hydrocarbon reserves in carbonate formations, and the need to simplify sandstone stimulation treatments, HF acid systems capable of creating differential sandstone surface dissolution patterns and creating acid fracture conductivity in sandstones, without the need for a proppant, have therefore been desired.

### SUMMARY OF THE INVENTION

The present invention is directed to a well treating composition containing a deformable particulate and an acidizing solution. When employed in acid fracturing, the aqueous composition of the invention acts as a reactive fluid wherein the acid differentially etches the rock. The well treating composition has particular applicability when used to enhance the productivity of hydrocarbons from both hydrocarbon bearing sandstone or siliceous formations and carbonate formations.

When used in sandstone formations, the acidizing solution may contain HF acid and/or a compound capable of generating HF acid subsequent to introduction of the acidizing solution into the wellbore. When used in carbonate formations, the acidizing solution typically contains HCl acid, formic acid, acetic acid, citric acid or a carboxylic acid.

The method of the invention consists of forming a partial mono-layer of the deformable particulates under high pressure in the formation. By so doing, the surface of the formation is partially blocked from reaction with the acidizing solution.

In a preferred embodiment, the deformable particulate is selected from at least one of crushed nut shells, ground or crushed seed shells, ground or crushed fruit pits, processed wood and organic polymeric materials, polystyrene, polystyrene divinylbenzene, polyamide, polyethylene, polyvinylacetate, polyvinylidene chloride, rubber or swellable rubber, solid paraffin beads, graphite, granulated carbon black, high viscosity greases and gilsonite. Typically, the apparent specific gravity (ASG) of the deformable particulate is between from about 0.85 to about 2.0. In a more preferred embodiment, the deformable particulate is a polystyrene divinylbenzene bead.

The acidizing solution may be introduced into the formation simultaneously with the deformable particulates. Alternatively, the acidizing solution may be introduced into the formation prior to introduction of the deformable particulates. Further, both the deformable particulates and a non-reactive fluid may be pumped into the formation; the non-reactive fluid containing at least one compound capable of generating HF acid within the formation. For example, the non-reactive fluid may contain ammonium hydroxyethedenediphosphonate, ammonium fluoride and methyl formate. In the presence of heat, the ester may be hydrolyzed to formic acid which, in turn, may initiate the formation of HF acid on the sandstone or carbonate formation surface.

The acidizing solution differentially etches around the deformable particulates. Conductive channels are therefore created on the surface of the formation.

The deformable particulates deform on closure. The resultant is thin wafered structures having a diameter larger than the diameter of the particulates introduced into the formation. These wafers have been seen to exist as “shields” and further to protect the formation which is adjacent the deformed wafers from reactive acid dissolution. After etching, the fracture face is riddled with uniformly spaced pillars made of un-reacted formation face. Thus, the conductive channels constitute that portion of the fracture face that is not protected by the deformed particulates.

### BRIEF DESCRIPTION OF THE DRAWINGS

In order to more fully understand the drawings referred to in the detailed description of the present invention, a brief description of each drawing is presented, in which:

FIG. 1 illustrates fracture width and post acid permeability and conductivity of a deformable particulate and acidizing solution used in accordance with the method of the invention.

FIG. 2 shows acid-etched sandstone fracture surfaces resulting from a partial monolayer of deformable particulates acidized with a HF system, after placement in a fracture conductivity cell under 1000 psi closure at 150° F.

### DETAILED DESCRIPTION OF THE PREFERRED EMBODIMENTS

The productivity of hydrocarbons from sandstone and carbonate formations of oil, gas and geothermal wells, as well as water injection wells, may be markedly enhanced by contacting the formation with a deformable particulate and an acidizing solution.

When used in sandstone formations, the acidizing solution is a HF-containing acidizing solution. Alternatively, it may contain a non-reactive fluoride compound which is capable of generating HF acid after being introduced into the formation.

When used in carbonate formations, the acidizing solution contains any acid commonly used in acid fracturing. Such acids include inorganic as well as organic acids. Preferred inorganic acids are hydrochloric acid. Preferred organic acids include formic acid, acetic acid, citric acid and carboxylic acids. In a preferred embodiment, the acidizing solution contains between from about 0.5 to about 15 weight percent HCl acid; between from about 0.5 to about 10 weight percent formic acid; between from about 0.5 to about 25 weight percent acetic acid; between from about 0.5 to about 50 weight percent citric acid; or between from about 0.5 to below the solubility limit (in solution) of a carboxylic acid. Such acids may further be used in the HF-acidizing solution when a sandstone formation is being treated in order to convert fluorides in the formation to acid. In addition, the acids may be used in a HF-acidizing solution to prevent or reduce precipitates from those reactions.

In a preferred mode, the acidizing solution contains an acid such as a dicarboxylic acid, polycarboxylic acid, diphosphinic acid or a polyphosphonic acid compound. When used in carbonate formations, such acids are useful in binding iron in order to prevent the formation of iron sulfide or iron hydroxide. When used in sandstone formations, such acids are useful in the binding of aluminum in order to prevent the occurrence of secondary precipitation of aluminosilicates, such as fluoroaluminosilicates.

Such dicarboxylic acids, polycarboxylic acids, diphosphinic acid and polyphosphonic acid compounds include chelating agents such as aminopolycarboxylic acids and sodium, potassium and ammonium salts thereof. N-hydroxyethyl-N,N′,N′-ethylenediaminetriacetic acid (HEDTA) and HEIDA (hydroxyethyliminodiacetic acid) are useful in the present process as free acids and their Na, K, NH₄⁺salts (and Ca salts). Other aminopolycarboxylic acid members, including EDTA, NTA (nitrilotriacetic acid), DTPA (diethylenetriaminepentaacetic acid), and CDTA (cyclohexylenediaminetetraacetic acid). Mixtures of such acids may further be employed.

Any acid containing HF with an excess of hydronium ions is applicable for use in the method of the invention for sandstone formations. Mixtures of HF and hydrochloric acid are often referred to as “mud” acids in the industry.

In one embodiment of the invention, the acidizing solution is preferably a buffered acidizing solution and typically exhibits a pH between from about 1.9 to about 4.8, more typically between from about 2.5 to about 4.5. In some circumstances, it may be desirable to employ an acidizing solution having a pH in excess of 4.0.

The acidizing solution for use in the invention may further contain one or more phosphonate compound, such as phosphonate acids or salts as well as esters thereof. Such systems may contain phosphonate materials of the formula:

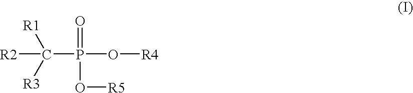

wherein R1, R2 and R3 may be hydrogen, alkyl, aryl, phosphonates, phosphates, acyl amine, hydroxy and carboxyl groups and R4 and R5 may consist of hydrogen, sodium, potassium, ammonium or an organic radical.

Examples of these materials include aminotri (methylene phosphonic acid) and its pentasodium salt, 1-hydroxyethylidene-1,1-diphosphinic acid and its tetrasodium salt, hexamethylenediaminetetra (methylene phosphonic acid) and its hexapotassium salt, and diethylenetriaminepenta (methylene phosphonic acid) and its hexasodium salt. Among the commercial phosphonate materials, preferred is 1-hydroxyethylidene-1,1-diphosphinic acid, otherwise known as “HV acid,” available in 60% strength as “DEQUEST 2010” from Solutia, Inc.

The concentration of the phosphonate in the acidizing solution is generally between from about 0.25 to about 50.0, preferably from about 0.5 to about 6.0, more preferably about 3, percent by volume of the total solution without regard to the acid concentration.

Further suitable acids for the acidizing solution are organic acids, such as citric acid, acetic acid, or formic acid as well as those set forth in U.S. Pat. No. 6,443,230, herein incorporated by reference. In a preferred mode, the acidizing solution contains both a phosphonate acid (set forth above) as well as the organic acid of this paragraph.

The amount of organic acid in the acidizing solution is typically between from about 1 to about 50 weight percent.

The composition of the invention (excluding the particulate and other agents and additives) typically contains between from about 3 to about 28 weight percent of total acid. (When a chelating agent is used, the total amount of acid may be between from about 1 to about 30 weight percent.) The aqueous acidizing solution may further contain less than about 3 weight percent, even as low as 0.5 weight percent, acid, though the total minimal acid should be at least about 3 weight percent. For instance, the acidizing solution may contain between from about 0.5 to about 15 weight percent of a single acid. Most preferably, between from about 5 to about 28 weight percent acid is used when the acid is hydrochloric acid. When hydrofluoric acid is used alone, the aqueous acidizing solution contains less than 9 weight percent acid. When formic acid is used, the aqueous fluid generally may contain less than about 10 weight percent formic acid. When acetic acid is used, the aqueous fluid generally may contain less than about 25 weight percent of acetic acid.

The HF-acidizing solution for sandstone formations may include HF or a non-reactive fluoride compound which is capable of generating HF acid after being introduced into the formation. As such, the non-reactive fluid becomes reactive subsequent to introduction of the non-reactive fluid into the formation. For example, the non-reactive fluid could be composed of ammonium hydroxyethedenediphosphonate, ammonium fluoride and methylformate. With heat, the ester will be hydrolyzed to formic acid, initiating the hydrofluoric acid reaction on the sandstone. Alternatively, the non-reactive fluid may become reactive by use of a material capable of reducing the pH of the acidizing solution in order to generate HF acid. This occurs after contact of the HF-containing acidizing solution with the sandstone formation. Suitable materials which may be present in the acidizing solution in order to in-situ generate HF acid include carboxylic acid esters (such as methyl formate), polyesters (such as polylactic acid and esters thereof), chloroacetate, an ester of chlorosulfonic acid, methyl sulfonylchloride, benzene sulfonylchloride and trichlorotoluene.

The HF acid dissolves siliceous materials within the formation. The amount of HF in the acidizing solution is generally between from about 0.5 to about 20.0 weight percent, preferably between from about 1.5 to about 6.0 weight percent. (HF acid is, by definition, a weak acid being only partially dissociated in water, pKa=3.19.)

Preferred for use in sandstone formations are those buffered acidizing solutions which are highly effective in dissolving and removing siliceous material. More preferred sandstone acidizing solutions are those which attack calcium carbonate slowly and which therefore are much less prone to the release of calcium ions and subsequent precipitation of calcium fluoride. In addition to being non-reactive with carbonate minerals, such solutions do not require clay dissolution for acid fracturing stimulation response and can be formulated to have high HF strength and activity. Preferred buffered acidizing solutions are those disclosed in U.S. Pat. Nos. 5,529,125 and 7,059,414, herein incorporated by reference. A particularly preferred sandstone acidizing solution for use in the invention is BJ Sandstone Acid (BJSSA), a product of BJ Services Company.

The deformable particulate is introduced into the formation as part of a slurry such that a partial monolayer of deformed particulates is created after closure pressure is exerted on the particulates. The increased pressure causes the particulates to deform. The acid of the acidizing solution thus etches around the contours of the particulates. As a result of such deformation, the formation surface is partially blocked from reaction with the acidizing solution. The conductive channels are therefore created on the formation surface as defined by the contours of the particulates. The increased permeability of the formation may be attributable to the unique etching patterns created due to the obstruction of acid reaction on the formation sandwiched between the deformable particulates of the partial monolayer.

The deformable particulates typically exhibit an apparent specific gravity (ASG) less than or equal to 2.0 and exhibit a deformation under conditions as low as 1,500 psi closure stress, but preferably under 100 psi and most preferably under 10 psi at 20° C. Deformation is defined as greater than 50% strain. The lightweight particulates exhibit deformation under conditions as low as 500 psi closure stress at 20° C. The deformable particulate is preferably a lightweight particulate having an apparent specific gravity (ASG) particulate between from about 0.85 to about 2.0.

Suitable deformable particulates include crushed nut shells, ground or crushed seed shells, ground or crushed fruit pits, processed wood and organic polymeric materials, polystyrene, polystyrene divinylbenzene, polyamide, polyethylene, polyvinylacetate, polyvinylidene chloride, rubber or swellable rubber, solid paraffin beads, graphite, granulated carbon black, high viscosity greases and gilsonite. In a preferred embodiment, the deformable particulate is a polystyrene divinylbenzene bead.

Under closure stresses, the particulates deform as the fracture face compresses the (non-dissolved) particulates. Wafered structures or raised “pedestals” are produced. The parts of the fracture face that is not protected by the pedestals is readily dissolved. The pedestals function like a partial monolayer of proppant by providing highly conductive channels. The pedestals have a diameter which is larger than the diameter of the deformable particulates introduced into the formation. The formation surfaces contiguous with the pedestals are protected from the reactive acid.

The creation of the partial monolayer reduces or eliminates fines damage during the process. Fracture acidizing with conventional proppant packs is discouraged since fines can migrate into the pack and plug fluid flow. The existence of such fines could substantially damage or choke strategic points after closure, and severely damage fluid flow pathways that could significantly impair hydrocarbon production. The creation of the partial monolayer therefore negates plugging.

In essence, the deformable particulates block the formation surface from reacting with the acidizing solution. Blockage of the formation surface by the partial monolayer prevents the HF acid to etch around and beneath the deformable particulates. The parts of the formation surface not protected by the pedestals are readily dissolved by the acid of the acidizing solution. As a result, conductive channels are differentially and non-uniformly etched onto the surface of the formation. A beneficial fracture width may thereby be created.

The deformable particulates may be pumped simultaneously with the acidizing solution wherein the injection pressure is immediately released after pumping of the treatment composition. Alternatively, the deformable particulates may be pumped ahead of the acidizing solution, preceding with partial release of injection pressure to allow deformation of the particulates. The acidizing solution may then be injected into the formation in order to create the fracture width.

The deformable particulate and acidizing solution may be introduced into the formation at a pressure sufficient to form a fracture within the formation.

### EXAMPLES

The following examples will illustrate the practice of the present invention in its preferred embodiments. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow.

Unless otherwise indicated, all percentages are expressed in terms of weight percent.

BJ Sandstone Acid (BJSSA), a product of BJ Services Company, was employed as the buffered HF-acidizing solution.

Conductivity tests were then performed according to API RP 61 (1^{st} Revision, Oct. 1, 1989) using an API conductivity cell with Ohio sandstone wafer inserts to simulate the producing formation. The test particulate was placed between the sealed sandstone wafers. The conductivity cell was then placed on a press while stress was applied at 100 psi/minute until the target temperature was reached. Fluid was then allowed to flow through the test pack maintaining Darcy flow. The differential pressure was measured across 5 inches of the pack using a “ROSEMOUNT” differential pressure transducer (#3051C). Flow was measured using Micromotion mass flow meters and data points were recorded every 2 minutes for 50 hours. An Isco 260D programmable pump applied and maintained effective closure pressure.

Sandstone acid fracturing conductivity was then tested with BJSSA and a polyamide particulate having an apparent specific gravity of approximately 1.5 using a 0.03 lb/ft² partial monolayer at 1000 PSI closure stress and 150° F. as set forth below:

1. An initial (zero) fracture width at 1000 PSI closure stress and room temperature was measured and permeability and conductivity was established with deionized water at 10 ml/min.

2. The cell was then heated from room temperature to 150° F. over approximately 1 hour at 1000 PSI closure stress.

3. After approximately 3 hours, the fracture width was measured and permeability and conductivity was established.

4. After a further 40 hours, the differential pressure was allowed to stabilize, the fracture width was measured and pre-acid injection permeability and conductivity was established.

5. A 2 weight percent ammonium chloride aqueous solution was then injected into the cell and the particulate pack and sandstone core slab was permitted to be saturated with the solution for one hour.

6. A volume of 540 ml of BJSSA (double the regular strength of normal BJSSA) was then injected into the cell at 6 ml/min for 90 minutes and then 500 ml was injected at 10 ml/min; approximately 800 ml of BJSSA was recovered at the outlet and then 600 ml of the recovered acid was reinjected at 10 ml/min through the fracture followed by an additional 100 ml injected through each rock slab as leakoff. The total volume of acid injected was approximately 1650 ml (fracture) and 200 ml (leak-off).

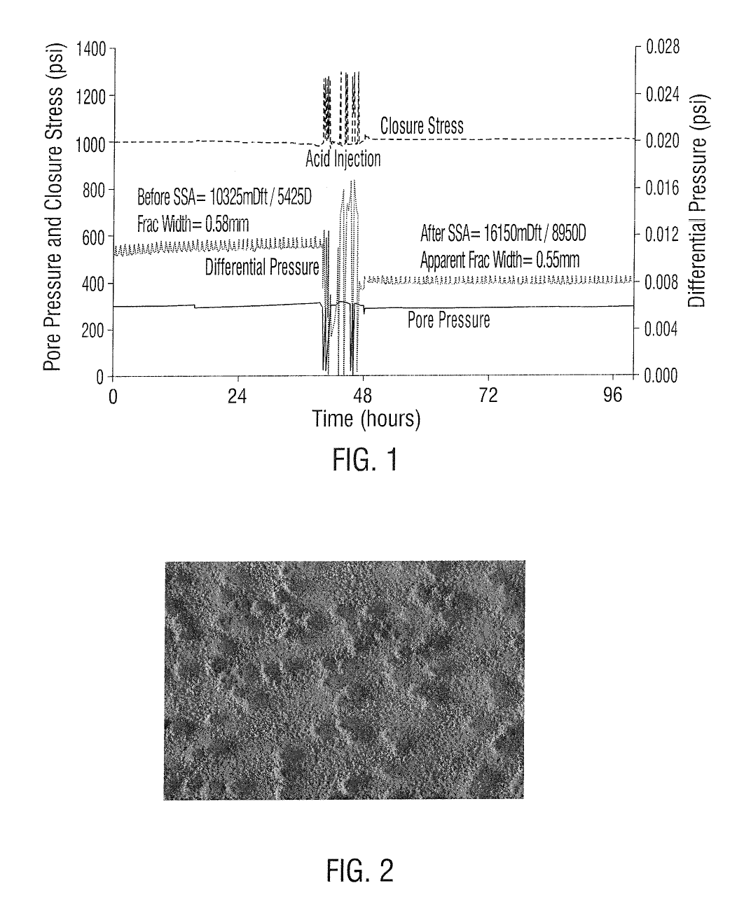

7. A 2 weight percent ammonium chloride aqueous solution was then injected into the particulate pack at 10 ml/min for one hour. Deionized water was then introduced and flow was continued at 10 ml/min until a stable differential pressure was reached. After 72 hours, the fracture width and post acid permeability and conductivity were measured. The results are set forth in FIG. 1 (wherein BJSSA is further abbreviated as “SSA”).

FIG. 2 shows acid-etched sandstone fracture surfaces wherein a partial monolayer of deformable “beads” was placed in a fracture conductivity cell and acidized with the same HF system under 1000 psi closure, 150° F., and 72 hours of residence time. Substantial surface dissolution occurred around the areas blocked by the deformable beads that blocked acid reaction non-uniformly—resulting in the creation of “pillars” that supported conductivity. The photograph of FIG. 2 was taken after the beads were removed.

From the foregoing, it will be observed that numerous variations and modifications may be effected without departing from the true spirit and scope of the novel concepts of the invention.

What is claimed is:

1. A method of enhancing the productivity of hydrocarbons from a sandstone or carbonate formation, the method comprising contacting the formation with (i.) a deformable particulate having an apparent specific gravity less than or equal to 2.0 and creating a partial monolayer in the formation; and (ii.) an acidizing solution.

2. The method of claim 1, wherein the deformable particulate and acidizing solution are simultaneously introduced into the formation.

3. The method of claim 1, wherein the deformable particulate is introduced into the formation prior to the introduction of the acidizing solution.

4. The method of claim 1, wherein the deformable particulate is introduced into the formation at a pressure sufficient to form a fracture within the formation.

5. The method of claim 1, wherein the acidizing solution further contains a phosphonate compound.

6. The method of claim 5, wherein the acidizing solution comprises a phosphonate of the formula: 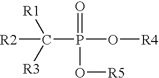
wherein R1, R2 and R3 are independently selected from hydrogen, alkyl, aryl, phosphonates, phosphates, acyl, amine, hydroxy and carboxyl groups and R4 and R5 are independently selected from hydrogen, sodium, potassium, ammonium or an organic radical.

7. The method of claim 1, wherein the acidizing solution further comprises a dicarboxylic acid, polycarboxylic acid, diphosphonic acid or a polyphosphonic acid compound.

8. The method of claim 1, wherein the acidizing solution contains an acid selected from the group consisting of HCl acid, formic acid, acetic acid, citric acid and a carboxylic acid.

9. The method of claim 1, wherein the acidizing solution contains at least one of the following:
(i.) between from about 0.5 to about 15 weight percent HCl acid;
(ii.) between from about 0.5 to about 10 weight percent formic acid;
(iii.) between from about 0.5 to about 25 weight percent acetic acid;
(iv.) between from about 0.5 to about 50 weight percent citric acid; or
(v.) between from about 0.5 to below the solubility limit (in solution) of a carboxylic acid.

10. The method of claim 5, wherein the amount of phosphonate compound in the acidizing solution is between from about 0.5 to about 50 weight percent.

11. The method of claim 1, wherein the deformable particulate is selected from the group consisting of crushed nut shells, ground or crushed seed shells, ground or crushed fruit pits, processed wood and organic polymeric materials, polystyrene, polystyrene divinylbenzene, polyamide, polyethylene, polyvinylacetate, polyvinylidene chloride, rubber or swellable rubber, solid paraffin beads, graphite, granulated carbon black, high viscosity greases and gilsonite and further wherein the apparent specific gravity (ASG) of the deformable particulate is between from about 0.85 to about 2.0.

12. The method of claim 11, wherein the deformable particulate is a polystyrene divinylbenzene bead.

13. The method of claim 1, wherein the acidizing solution is a HF-containing acidizing solution.

14. The method of claim 13, wherein the HF-containing acidizing solution contains HF acid or a fluoride compound capable of generating HF acid to dissolve siliceous materials within the formation.

15. The method of claim 1, wherein the acidizing solution comprises (i.) HCl acid, formic acid, acetic acid, citric acid or a carboxylic acid; (ii.) HF acid or a fluoride compound in sufficient concentration to HF acid; and (iii.) a phosphonate compound.

16. The method of claim 13, wherein the acidizing solution is a pH-buffered HF-containing acidizing solution having a pH between from about 1.9 to about 4.8.

17. The method of claim 1, wherein the acidizing solution comprises a (i.) a compound capable of generating HF acid; and (ii.) a compound capable of reducing the pH of the acidizing solution in order to generate HF acid from (i.) after contact of the HF-containing acidizing solution with the sandstone or carbonate formation.

18. The method of claim 1, wherein the formation is a carbonate formation.

19. A method of increasing the permeability of a sandstone or carbonate formation comprising the steps of:
(a) contacting the formation with (i.) an acidizing solution; and (ii.) a deformable particulate having an apparent specific gravity less than or equal to 2.0;
(b) creating a partial monolayer at high pressure in the formation with the deformable particulate wherein the formation surface is partially blocked from reaction with the acidizing solution; and
(c) differentially etching the acidizing solution around the deformable particulates, thereby creating conductive channels on the surface of the formation.

20. The method of claim 19, wherein the deformable particulate is either simultaneously introduced into the formation with the acidizing solution or prior to the introduction of the acidizing solution.

21. The method of claim 19, wherein the acidizing solution further contains a phosphonate compound.

22. The method of claim 19, wherein the deformable particulate is selected from the group consisting of crushed nut shells, ground or crushed seed shells, ground or crushed fruit pits, processed wood and organic polymeric materials, polystyrene, polystyrene divinylbenzene, polyamide, polyethylene, polyvinylacetate, polyvinylidene chloride, rubber or swellable rubber, solid paraffin beads, graphite, granulated carbon black, high viscosity greases and gilsonite and further wherein the apparent specific gravity (ASG) of the deformable particulate is between from about 0.85 to about 2.0.

23. The method of claim 19, wherein the acidizing solution is a HF-containing acidizing solution.

24. The method of claim 23, wherein the acidizing solution is a pH-buffered HF-containing acidizing solution having a pH between from about 1.9 to about 4.8.

25. A well treating composition comprising a deformable particulate and a buffered HF-sandstone acidizing solution.

26. The composition of claim 25, wherein the pH of the acidizing solution is between from about 1.9 to about 4.8.

27. The composition of claim 25, wherein the acidizing solution further comprises a phosphonate of the formula: 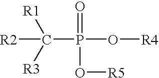
wherein R1, R2 and R3 are independently selected from hydrogen, alkyl, aryl, phosphonates, phosphates, acyl, amine, hydroxy and carboxyl groups and R4 and R5 are independently selected from hydrogen, sodium, potassium, ammonium or an organic radical.

28. The composition of claim 25, wherein the deformable particulate is selected from the group consisting of crushed nut shells, ground or crushed seed shells, ground or crushed fruit pits, processed wood and organic polymeric materials, polystyrene, polystyrene divinylbenzene, polyamide, polyethylene, polyvinylacetate, polyvinylidene chloride, rubber or swellable rubber, solid paraffin beads, graphite, granulated carbon black, high viscosity greases and gilsonite and further wherein the apparent specific gravity (ASG) of the deformable particulate is between from about 0.85 to about 2.0.
